(19) United States
(12) Patent Application Publication
(10) Pub. No.: US 2010/0103394 A1
(43) Pub. Date: Apr. 29, 2010

(54) REFLECTION PROJECTION OPTICAL SYSTEM, EXPOSURE APPARATUS, AND METHOD OF MANUFACTURING DEVICE

(75) Inventor: Chiaki Terasawa, Nasushiobara-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/606,898

(22) Filed: Oct. 27, 2009

(30) Foreign Application Priority Data
Oct. 28, 2008 (JP) 2008-277376

(51) Int. Cl. G03B 27/70

(52) U.S. Cl. 355/66; 355/77

(57) ABSTRACT

A reflection projection optical system projects a pattern positioned on an object plane onto an image plane via a mirror. The system has bilateral telecentricity on a side of the object plane and a side of the image plane, and has the object plane and the image plane positioned to be tilted with respect to a plane perpendicular to an optical axis of the system so as to satisfy a Scheimpflug condition.

### BACKGROUND OF THE INVENTION

1. Field of the Invention

The present invention relates to a reflection projection optical system, an exposure apparatus, and a method of manufacturing a device. More particularly, the present invention relates to a reflection projection optical system, an exposure apparatus, and a method of manufacturing a device, which perform projection exposure of processing objects.

2. Description of the Related Art

A projection exposure apparatus that typifies semiconductor manufacturing exposure apparatuses includes a projection optical system which projects a pattern formed on a mask (reticle) onto a wafer. A resolution (a minimum feature size that can be precisely transferred) R of a projection exposure apparatus is given by:

R=k₁×(λ/NA) (1)

where λ is the wavelength of a light source, and NA is the numerical aperture of a projection optical system.

According to this principle, the shorter the wavelength or the higher the NA, the better the resolution. Only increasing the NA as before has reached a practical limit beyond which it is no longer possible to meet the recent demand for a higher resolution. Under the circumstance, shortening the wavelength is expected to improve the resolution. The current mainstream exposure light sources are a KrF excimer laser (wavelength: about 248 nm) and an ArF excimer laser (wavelength: about 193 nm). At the same time, practical application of an exposure apparatus which uses EUV light is in progress.

When the exposure light is EUV light, there exists no glass material usable for a projection optical system, and, naturally, the projection optical system can include no lens. To combat this issue, various types of reflection reduction projection optical systems including only mirrors have been proposed. For the same reason as in a projection optical system, there exists no transmissive reticle which transmits EUV light, so a reflective reticle having a reflective film pattern formed from a multi-layer film is used for EUV light.

Conventionally, for the use of a reflective reticle, a projection optical system is a non-telecentric system having an incident pupil set, for example, at a finite distance from the object plane. This is to guide light reflected by an illumination system to the projection optical system. In this case, if the relative position of the object plane in the optical axis direction shifts during scanning exposure, the magnification and distortion aberration on the image plane are prone to change, resulting in degradation in imaging performance. Japanese Patent Laid-Open Nos. 2000-100703, 2001-332489, 2003-045782, and 2003-233001 disclose conventional techniques which ensure telecentricity on the object plane side in order to reduce the adverse effect of this issue.

Conventional techniques which use a reflective reticle have the following shortcomings: telecentricity on the object side is imperfect; a given degree of freedom of the positioning of illumination system mirrors and a given imaging region are not ensured; and a high NA is not attained. For example, the arrangement described in Japanese Patent Laid-Open No. 2000-100703 includes a first concave mirror positioned adjacent to the object plane, and therefore does not secure a space wide enough to accommodate illumination system mirrors. In addition, this arrangement has imperfect telecentricity on the object side as follows. Although this arrangement attains an NA of about 0.1, any attempt to attain an NA higher than this value results in divergence of a light beam. This further deteriorates telecentricity on the object side.

Japanese Patent Laid-Open No. 2001-332489 describes an embodiment in which a reflective reticle is used. In this embodiment, an Offner type projection system is used and set to have bilateral telecentricity on both the object side and the image side, and a reticle and a wafer are symmetrically positioned to be tilted with respect to the optical axis. Unfortunately, the positioning of a reticle and a wafer described in Japanese Patent Laid-Open No. 2001-332489 prevents the object plane and the image plane from satisfying the Scheimpflug condition, so the image plane degrades in imaging performance. This makes it impossible to ensure a sufficient effective image plane width, and makes it difficult to attain a higher NA.

The arrangement described in Japanese Patent Laid-Open No. 2003-045782 has been proposed by the inventor of the present invention, and is relatively easy to ensure telecentricity on the object side. However, because the light beam height from the object plane increases or is parallel to the optical axis, it is difficult to position illumination system mirrors for illuminating a reflective reticle. The use of a reflective reticle is to virtually lowering telecentricity on the object side to some extent. A reflection projection optical system described in Japanese Patent Laid-Open No. 2003-233001 has also been proposed by the inventor of the present invention. The reflection projection optical system described in this patent reference increases the light beam height from the object plane, and therefore attains nearly perfect telecentricity on the object side, as in that described in Japanese Patent Laid-Open No. 2003-045782. This again makes it difficult to position illumination system mirrors for illuminating a reflective reticle. Furthermore, the reflection projection optical systems described in Japanese Patent Laid-Open Nos. 2003-045782 and 2003-233001 do not show details of how to position the object plane and the image plane to be tilted with respect to a plane perpendicular to the optical axis.

Assume the use of a reflection projection optical system which has an incident pupil set at a finite distance from the object plane, that is, serves as a non-telecentric system. In this case, the difference in NA for each image height in the effective region may be an issue. The difference in NA for each image height in the effective region is accounted for by the fact that the angle of the principal ray as the center of a light beam with respect to the incident pupil changes for each image height. More specifically, as shown in FIG. 4, when the principal rays from object heights 1 and 2, and the angles between these principal rays and the NAs on the object side at object heights 1 and 2 are indicated by an alternate long and two short dashed line and θ1 and an alternate long and short dashed line and θ2, θ1<θ2. In addition, the exit pupil of the illumination system is also set at a finite distance from the object plane to be compatible with the incident pupil of the projection optical system. For this reason, the angle of the principal ray changes for each object height in the illumination region on the object plane as well. That is, upon irradiating a three-dimensional structural pattern on the reflective reticle, the influence of a shadowy portion of an absorbing layer changes for each object height. This causes a difference in amount of reflected light attributed to the image height, and therefore degrades the uniformity of the CD (Critical Dimension) in the effective field. This is obvious from the fact that two light beams which become incident on the reflective reticle at different incident angles have different widths depending on the level of the absorbing layer, as shown in FIG. 5. To reduce this adverse effect, a reticle is to be designed by optimizing the thickness and transparency of an absorbing layer by, for example electromagnetic field analysis. A projection optical system for EUV light processes a miniaturization target with a precision as high as 32 nm or less, and has high sensitivity to CD uniformity because it includes optical elements all of which are formed from mirrors. To meet these conditions, it is important to suppress the difference in NA for each image height and the difference in amount of reflected light attributed to the object height, as described above. Furthermore, deterioration in reticle evenness turns into an image shift on the image plane, degrading the overlay performance.

### SUMMARY OF THE INVENTION

According to an aspect of the present invention, there is provided a reflection projection optical system which projects a pattern positioned on an object plane onto an image plane via a reflecting mirror, wherein the system has bilateral telecentricity on a side of the object plane and a side of the image plane, and has the object plane and the image plane positioned to be tilted with respect to a plane perpendicular to an optical axis of the reflection projection system so as to satisfy a Scheimpflug condition.

Further features of the present invention will become apparent from the following description of exemplary embodiments with reference to the attached drawings.

### BRIEF DESCRIPTION OF THE DRAWINGS

FIG. 1 is a schematic sectional view showing an exemplary embodiment of a reflection projection optical system according to the present invention, and its optical path;

FIG. 2 is a schematic diagram illustrating an example of the arrangement of an exposure apparatus including the reflection projection optical system shown in FIG. 1;

FIG. 3 is a plan view showing another relationship between the optical axis and the projected image formation possible region (effective image region) on the object plane of the projection optical system shown in FIG. 1;

FIG. 4 is a diagram for explaining the difference in NA attributed to non-telecentricity on the object side in the prior art;

FIG. 5 is a schematic view for explaining the influence of a shadow of an absorbing layer on a reflective reticle attributed to non-telecentricity in the prior art;

FIG. 6 is a schematic sectional view showing an exemplary embodiment of a reflection projection optical system with non-telecentricity on the object side according to the prior art, and its optical path; and

FIG. 7 is a schematic sectional view showing another embodiment of a reflection projection optical system according to the present invention.

### DESCRIPTION OF THE EMBODIMENTS

A reflection projection optical system 100 and exposure apparatus 200 according to the present invention will be described below with reference to the accompanying drawings. However, the present invention is not limited to the following embodiments, and each constituent element may be alternatively substituted by another one within the scope in which the object of the present invention is achieved. Note that the same reference numerals denote the same members throughout the drawings, and a repetitive description thereof will not be given.

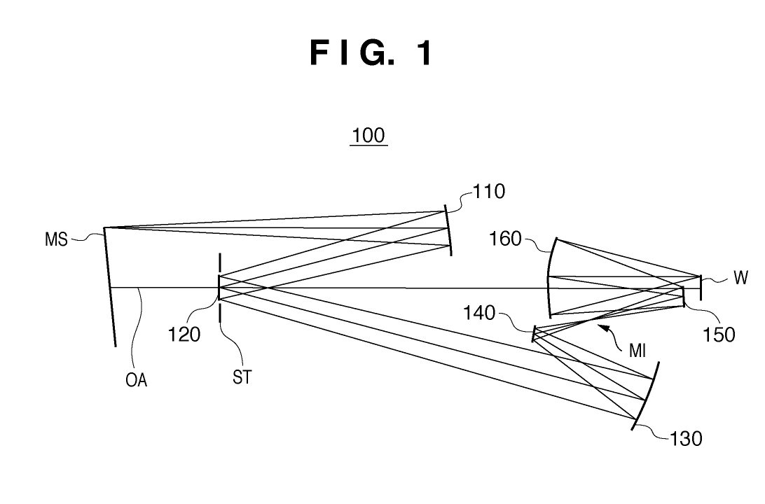

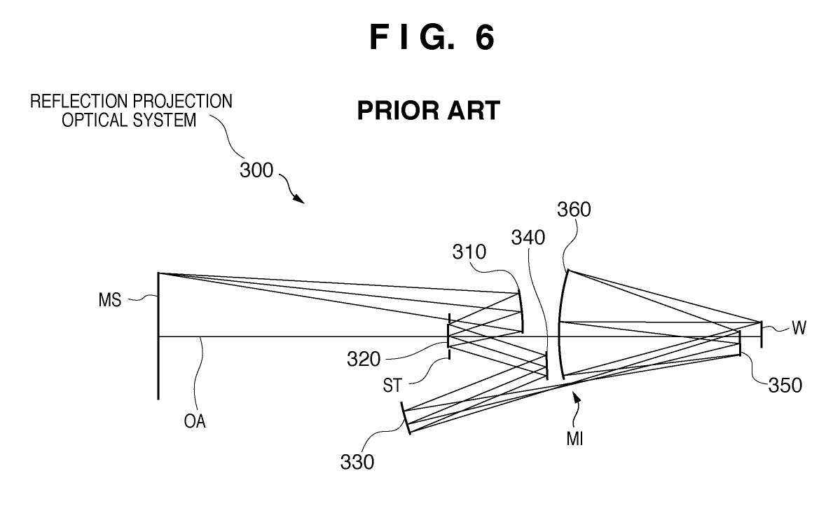

FIG. 1 is a schematic sectional view showing an exemplary embodiment of the reflection projection optical system 100 according to the present invention, and its optical path. Also, FIG. 6 is a schematic sectional view showing a reflection projection optical system 300 with non-telecentricity on the object side according to the prior art, and its optical path.

Referring to FIG. 1, the reflection projection optical system 100 (to be simply referred to as a “projection optical system 100” hereinafter) according to the present invention is a reflection reduction projection optical system which reduces and projects the pattern on an object plane MS (e.g., a reflective reticle surface) onto an image plane W (e.g., a processing object such as a substrate). In one embodiment, the projection optical system 100 is especially suitable for EUV light (wavelength: 13.4 nm etc.), and attains a numerical aperture (NA) of 0.25.

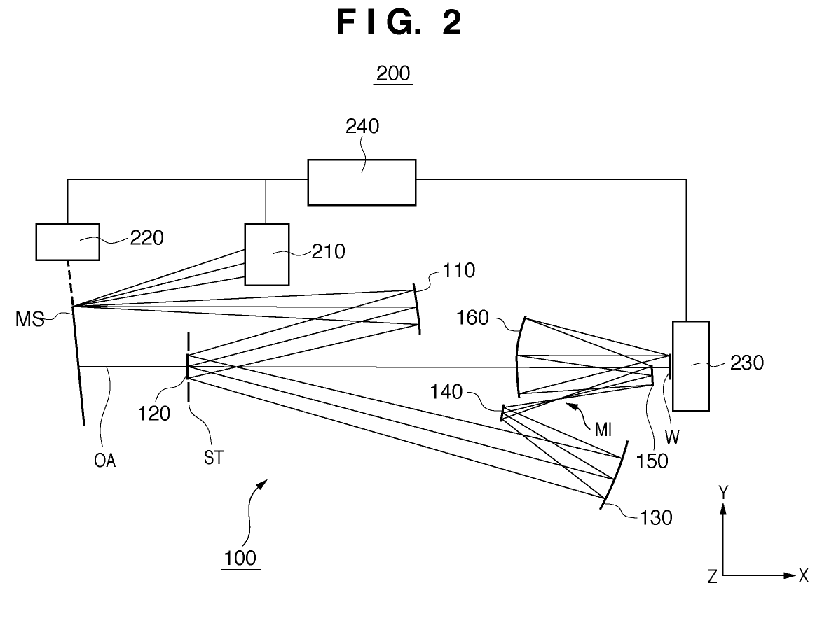

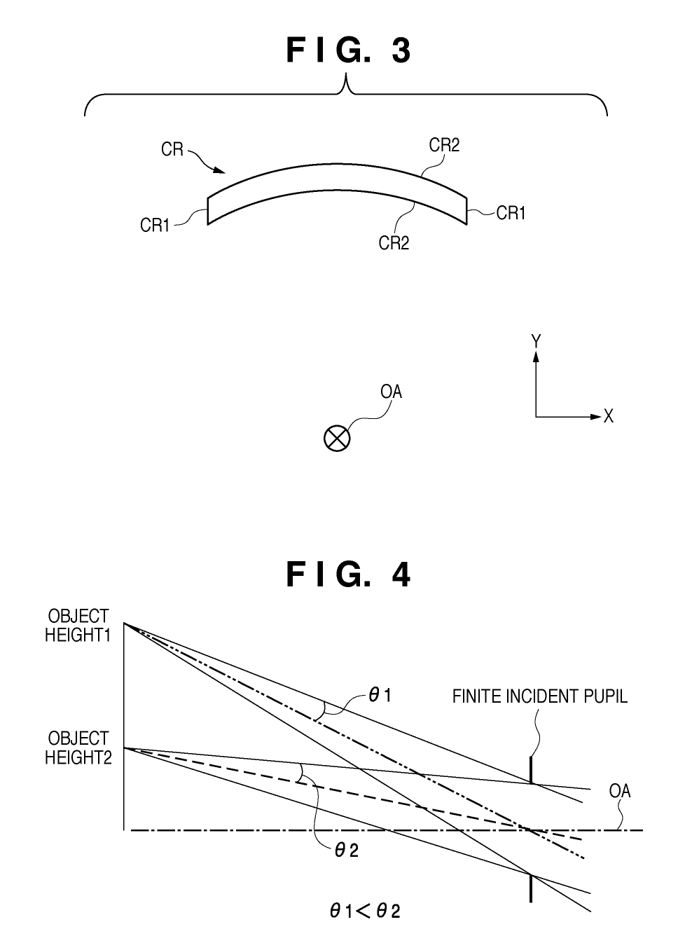

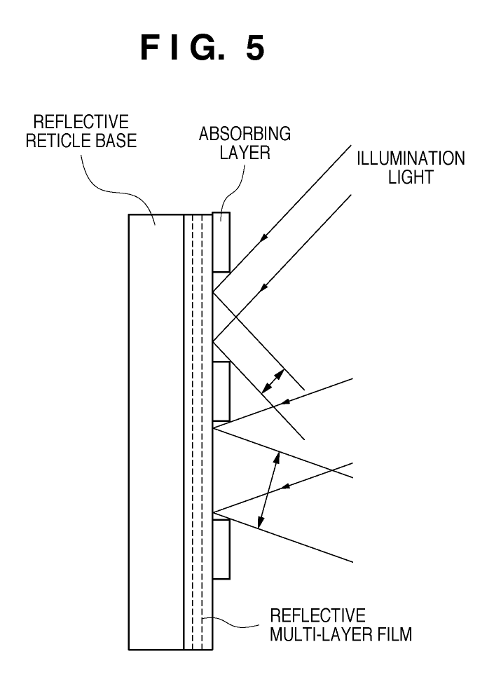

The projection optical system 100 includes six reflecting mirrors 110 to 160. The object plane MS is basically an off-axis ring-like plane, as shown in FIG. 3. The first to sixth reflecting mirrors 110 to 160 are sequentially positioned in the optical path in the order in which they reflect the light from the object plane MS (FIG. 2). The first, third, and sixth reflecting mirrors 110, 130, and 160 are concave mirrors. The second, fourth, and fifth reflecting mirrors 120, 140, and 150 are convex mirrors. The four, first to fourth reflecting mirrors 110 to 140 form an intermediate image MI of a real image. The two, fifth and sixth reflecting mirrors 150 and 160 form the intermediate image MI again on the image plane W. The projection optical system 100 according to the present invention is basically positioned to form a coaxial system. More specifically, the projection optical system 100 is a coaxial optical system symmetrical about one optical axis OA, and includes an aperture stop ST positioned at the position of the second reflecting mirror 120. The diameter of the aperture stop ST may be fixed or variable. If the aperture stop ST is a variable aperture stop, the NA of the optical system can be changed by changing the diameter of the aperture stop ST. Using a variable aperture stop as the aperture stop ST makes it possible to obtain a large depth of focus and stabilize the image formed.

FIG. 3 shows the off-axis ring-like object plane MS. An effective field region CR within which a projected image can be formed has a shape surrounded by two sides CR1 that are parallel straight lines, and arcs CR2 that have the same curvature and central angle. The effective field region CR does not include the optical axis OA.

With this arrangement, the projection optical system 100 according to the present invention forms nearly perfect bilateral telecentricity on both the object plane side and the image plane side. To position a reflective reticle on the object plane MS, the object plane MS is tilted with respect to a plane perpendicular to the optical axis OA. This arrangement successfully splits illumination light guided from an illumination system to a reflective reticle, and that reflected by the reflective reticle toward a projection optical system. This makes it possible to increase the degree of freedom of the positioning of illumination system mirrors in accordance with the setting of the tilt angle of the reflective reticle. At the same time, the image plane W is tilted with respect to a plane perpendicular to the optical axis OA, so as to satisfy the so-called Scheimpflug condition, in accordance with the tilt of the object plane MS. Hence, the projection optical system 100 according to the present invention can ensure a sufficient width of the image plane in the effective field region CR.

The projection optical system 100 according to this embodiment has an intermediate image MI of one real image, and forms the intermediate image MI twice as a whole. To implement this, both the object plane MS and image plane W are tilted counterclockwise within the paper plane with respect to a plane perpendicular to the optical axis OA. That is, in accordance with the Scheimpflug condition, the object plane MS and image plane W are tilted in the same direction if the projection optical system 100 forms an image even-numbered times as a whole, and they are tilted in opposite directions if the projection optical system 100 forms an image odd-numbered times as a whole.

Also, the projection optical system 100 according to the present invention forms nearly perfect bilateral telecentricity on both the object plane side and the image plane side. For this reason, even when the relative position between the object plane and the image plane in the optical axis direction shifts during scanning exposure using the reticle and the substrate, it is possible to satisfactorily maintain a given imaging performance by suppressing changes in magnification and distortion aberration on the image plane. It is also possible to reduce degradation in overlay performance attributed to deterioration in reticle evenness, which may be an issue encountered when the projection optical system has non-telecentricity.

The formation of telecentricity on the object side decreases the difference in NA for each image height in the effective field region, as compared to the conventional non-telecentric system. Also, the formation of telecentricity prevents the occurrence of a light amount difference attributed to the object height in a shadowy portion of the absorbing layer on the three-dimensional pattern. This is obvious because the formation of telecentricity allows the principal ray of illumination light to become incident on the reflective reticle at a predetermined angle, independently of the illumination range. In sum, since the formation of telecentricity can decrease the differences in NA and amount of light reflected by the reticle for each image height, it is possible to reduce factors of deterioration in CD uniformity in the effective field even in the conventional projection optical system.

From the foregoing, the projection optical system 100 according to the present invention increases the degree of freedom of the positioning of illumination system mirrors, can attain good CD uniformity over the entire effective field region, and can reduce degradation in overlay performance.

The tilt angle θ can satisfy:

sin⁻¹(NAO)<θ<sin⁻¹(NAO)+5.0 (2)

where θ (°) is the tilt angle of the object plane MS with respect to a plane perpendicular to the optical axis OA, and NAO is the numerical aperture of the projection optical system 100 on the side of the object plane MS.

Inequality (2) defines the relationship between the tilt angle θ of the object plane MS and the NA of the projection optical system 100 on the object side. Assume that the tilt angle e falls below sin⁻¹(NAO) that is a lower limit. In this case, it is difficult to split light which becomes incident on the reflective reticle and that reflected by the reflective reticle. Also, it is virtually difficult to position illumination system mirrors. Assume that the tilt angle e exceeds [sin⁻¹(NAO)+5.0] that is an upper limit. In this case, the incident angle of illumination light which becomes incident on the reflective reticle is so large that a shadow of the absorbing layer on the pattern adversely affects a projected image. This state may be undesirable also because it is difficult to optimize the thickness and transparency of the absorbing layer in reticle design. From the viewpoint of ensuring a given fidelity of a projected image and a given degree of freedom of reticle design, the tilt angle of the object plane can be minimized while taking account of the positioning of illumination system mirrors. Hence, the tilt angle θ can satisfy:

sin⁻¹(NAO)<θ<sin⁻¹(NAO)+3.0 (3)

In this embodiment, the first to sixth reflecting mirrors 110 to 160 each include a concave mirror or a convex mirror, which has an aspherical reflecting surface, as described above. However, at least one of the first to sixth reflecting mirrors 110 to 160 is to have an aspherical reflecting surface. Nevertheless, an aspherical reflecting mirror can be formed from the viewpoint of aberration correction. Consequently, the projection optical system 100 according to the present invention includes aspherical reflecting mirrors as many as possible, irrespective of the number of aspherical reflecting mirrors used. An aspherical shape is described by a general expression:

$$Z = \frac{{ch}^{2}}{1 + \sqrt{1 - ( 1 + k ) {c}^{2} {h}^{2}}} + {Ah}^{4} + {Bh}^{6} + {Ch}^{8} + {Dh}^{10} + {Eh}^{12} + {Fh}^{14} + {Gh}^{16} + {Hh}^{18} + {Jh}^{20} + … \qquad ( 4 )$$

where Z is the coordinate in the optical axis direction, c is the curvature (the reciprocal of a radius of curvature r), h is the height from the optical axis, k is a conic constant, and A, B, C, D, E, F, G, H, and J are the fourth-, sixth-, eighth-, 10th-, 12th-, 14th-, 16-th, 18th-, and 20th-order aspherical coefficients, respectively.

In this embodiment, the six, first to sixth reflecting mirrors 110 to 160 have a Petzval sum around zero in order to even the image plane W of the projection optical system 100. That is, the sum of the refractive powers on the surfaces of reflecting mirrors can be around zero, irrespective of the number of reflecting mirrors used. In other words, the radius of curvature of the i-th mirror from the object plane MS satisfies:

$$\begin{matrix}{\sum }_{i = 1}^{n} ( \frac{1}{{r}_{2 i - 1}} - \frac{1}{{r}_{2 i}} ) = 0 \\ or & ( 5 ) \\ {\sum }_{i = 1}^{n} ( \frac{1}{{r}_{2 i - 1}} - \frac{1}{{r}_{2 i}} ) \approx 0 & ( 6 )\end{matrix}$$

where rᵢ is the radius of curvature of the i-th mirror from the object plane MS.

The surfaces of the first to sixth reflecting mirrors 110 to 160 are coated with multi-layer films which reflect EUV light. The multi-layer film acts to allow light beams to reinforce each other. Examples of a multi-layer film applicable to the first to sixth reflecting mirrors 110 to 160 in this embodiment are an Mo/Si multi-layer film formed by alternately stacking molybdenum (Mo) layers and silicon (Si) layers on a reflecting surface, and an Mo/Be multi-layer film formed by alternately stacking Mo layers and beryllium (Be) layers on a reflecting surface. If light having a wavelength range around a wavelength of 13.4 nm is used, a reflecting mirror formed from a Mo/Si multi-layer film can obtain a reflectance of 67.5%. Also, if light having a wavelength range around a wavelength of 11.3 nm is used, a reflecting mirror formed from a Mo/Be multi-layer film can obtain a reflectance of 70.2%. However, a multi-layer film usable in the present invention is not limited to the above-mentioned materials, and a description of these materials is not intended to restrict the use of a multi-layer film having the same action and effect as them.

The experimental results of illumination using the projection optical system 100 according to this embodiment and the reflection projection optical system 300 as a comparison target will be described. The reflection projection optical system 300 has almost the same specification as that of the projection optical system 100 according to this embodiment, but has non-telecentricity on the object side.

In FIG. 1, reference symbol MS denotes a reflective reticle positioned on the object plane; and W, a substrate (wafer) positioned on the image plane. The reflective reticle MS is tilted at 6.0° counterclockwise within the paper plane with respect to a plane (not shown) perpendicular to an optical axis OA. The wafer W is tilted at 1.2° counterclockwise within the paper plane with respect to a plane (not shown) perpendicular to the optical axis OA so as to satisfy the Scheimpflug condition. A reflection projection optical system 100 illuminates the reflective reticle MS by an illumination system (not shown) which emits EUV light having a wavelength around 13.4 nm. At this time, the principal ray of the illumination light is also set to become incident on the reflective reticle MS at a predetermined angle independently of the illumination range, and to match telecentricity on the object side of the projection optical system 100. The EUV light reflected by the reflective reticle MS is reflected again by first to sixth reflecting mirrors 110 to 160 in this order. The first, third, and sixth reflecting mirrors 110, 130, and 160 are concave mirrors. The second, fourth, and fifth reflecting mirrors 120, 140, and 150 are convex mirrors. The reflected light forms a reduced image of the pattern of the reflective reticle MS on the wafer W positioned on the image plane. The reflected light also forms an intermediate image MI of a real image between the fourth and fifth reflecting mirrors 140 and 150 along the optical path. Note that the projection optical system 100 according to this embodiment has the following performance:

an NA=0.25;

a reduction magnification=⅕×;

an arcuated image plane with an object height=130 mm to 140 mm, an image height=26 mm to 28 mm, and a width of 2.0 mm (corresponding to an arcuated slit, shown in FIG. 3, with a length in the X direction of 26 mm and a width in the Y direction of 2 mm); and

an overall length=1386 mm (the overall length in the optical axis direction at an object height=135 mm).

Table 1 shows the numeric values (the radius of curvature R, the surface interval D, the refractive index N, the tilt angle θ, the conic constant k, and the aspherical coefficients) of the projection optical system 100 according to this embodiment shown in FIG. 1. Note that D is the distance on the optical axis OA.

TABLE 1

| reflecting | | | | |
|---|---|---|---|---|
| mirror | | | | tilt angle θ |
| number | R | D | N | (°) |
| object | inf | 796.5429302 | 1 | 6.0 |
| plane (MS) | | | | |
| reflecting | −1097.4731266 | −543.4061114 | −1 | |
| mirror 110 | | | | |
| reflecting | −1127.4977971 | 1045.7739955 | 1 | |
| mirror 120 | | | | |
| reflecting | −670.5187509 | −305.5083085 | −1 | |
| mirror 130 | | | | |
| reflecting | −688.4311575 | 338.5054881 | 1 | |
| mirror 140 | | | | |
| reflecting | 367.3738672 | −313.5054881 | −1 | |
| mirror 150 | | | | |
| reflecting | 380.6082254 | 354.0722830 | 1 | |
| mirror 160 | | | | |
| image | inf | | | 1.2 |
| plane (W) | | | | |

Note that the tilt angle is the angle with respect to a plane perpendicular to the optical axis.

aspherical
data

| reflecting | | | |
|---|---|---|---|
| mirror | | | |
| number | k | A | B |
| reflecting | 0.368635781 | 1.931457721E−11 | −1.045628663E−16 |
| mirror 110 | | | |
| reflecting | 4.545006529 | 1.192393630E−08 | 1.042626764E−12 |
| mirror 120 | | | |
| reflecting | −0.716504964 | −2.276945942E−10 | −3.725250832E−16 |
| mirror 130 | | | |
| reflecting | 2.166125471 | 5.154309993E−09 | −1.204769501E−13 |
| mirror 140 | | | |
| reflecting | 7.937015425 | 1.632969649E−08 | 6.853782451E−13 |
| mirror 150 | | | |
| reflecting | 0.009292972 | 2.398169851E−11 | 1.415378684E−16 |
| mirror 160 | | | |

| reflecting | | | |
|---|---|---|---|
| mirror | | | |
| number | C | D | E |
| reflecting | 4.276591593E−21 | −5.799569212E−26 | 2.935528328E−31 |
| mirror 110 | | | |
| reflecting | 1.013137583E−16 | −2.270488253E−20 | 1.447202666E−23 |
| mirror 120 | | | |
| reflecting | 3.141527897E−23 | −2.476014101E−27 | 1.022474097E−33 |
| mirror 130 | | | |
| reflecting | 5.442392145E−18 | −1.543550680E−22 | 1.871079469E−27 |
| mirror 140 | | | |
| reflecting | 6.563411101E−18 | 2.386153689E−20 | −3.055192970E−24 |
| mirror 150 | | | |
| reflecting | −2.248979840E−22 | 5.541113890E−26 | −1.780070163E−30 |
| mirror 160 | | | |

| reflecting | | | | |
|---|---|---|---|---|
| mirror | | | | |
| number | F | G | H | J |
| reflecting | 0.000000000E+00 | 0.000000000E+00 | 0.000000000E+00 | 0.000000000E+00 |
| mirror 110 | | | | |
| reflecting | 0.000000000E+00 | 0.000000000E+00 | 0.000000000E+00 | 0.000000000E+00 |
| mirror 120 | | | | |
| reflecting | 0.000000000E+00 | 0.000000000E+00 | 0.000000000E+00 | 0.000000000E+00 |
| mirror 130 | | | | |
| reflecting | 0.000000000E+00 | 0.000000000E+00 | 0.000000000E+00 | 0.000000000E+00 |
| mirror 140 | | | | |
| reflecting | 0.000000000E+00 | 0.000000000E+00 | 0.000000000E+00 | 0.000000000E+00 |
| mirror 150 | | | | |
| reflecting | 0.000000000E+00 | 0.000000000E+00 | 0.000000000E+00 | 0.000000000E+00 |
| mirror 160 | | | | |

In the projection optical system 100 shown in table 1, θ=6.0°, NAO=0.05, and sin⁻¹(NAO)=2.866°. Since 2.866°<6.0°<2.866°+5.0°, the projection optical system shown in table 1 satisfies inequality (2).

The tilt angle θ of the reflective reticle MS can be changed by taking account of the positioning of illumination system mirrors. For example, the projection optical system also satisfies inequality (3) for 0=3.0°because 2.866°<3.0°<2.866°+3.0°. In this case, the surface interval D of the reflective reticle MS in table 1 is 803.6179804 mm.

The projection optical system satisfies inequality (2) for 0=7.0° because 2.866°<7.0°<2.866°+5.0°. In this case, the surface interval of the reflective reticle MS in table 1 is 794.1322645 mm.

Assume that the projection optical system 100 has perfect telecentricity on the image side. Then, a tangent function which describes the telecentricity characteristic on the object side has a maximum value of 0.000342 at an object height of 130 mm, and has a minimum value of 0.000022 at an object height of 140 mm. This means that the projection optical system 100 has nearly perfect telecentricity on the object side.

Assuming that deterioration in evenness of the reflective reticle MS is 100 nm, the tangent value for a projected image at an object height of 130 mm is 0.000342. Moreover, since a reduction magnification=⅕×, an image shift on the image plane is 0.00684 nm. This means that the adverse effect that the image shift inflicts on the overlay performance is negligible.

An NA variable aperture ST is positioned on the second reflecting mirror 120, and defines all light beams involved in imaging. Table 2 shows the NA on the image plane corresponding to each object height at this time.

TABLE 2

| object height (mm) | NA(meri) | NA(sagi) | ΔNA(m-s) |
|---|---|---|---|
| 130 | 0.25065 | 0.25997 | 0.00932 |
| 135 | 0.25053 | 0.25993 | 0.00940 |
| 140 | 0.25040 | 0.25988 | 0.00948 |
| ΔNA image height | 0.00025 | 0.00009 | |
| difference | | | |

NA(meri) is the meridional NA, NA(sagi) is the sagittal NA, the ΔNA image height difference is the maximum difference in NA for all image heights, and ΔNA(m-s) is the difference between the meridional and sagittal NAs at each image height. Table 2 reveals that the difference in NA between image heights is small.

FIG. 6 is a schematic sectional view showing a reflection projection optical system 300 with non-telecentricity on the object side according to the prior art, and its optical path. A reflective reticle MS positioned on the object plane has a surface perpendicular to an optical axis OA. Accordingly, a wafer W positioned on the image plane has a surface perpendicular to the optical axis OA as well. In one embodiment, the reflection projection optical system 300 illuminates the reflective reticle MS by an illumination system (not shown) which emits EUV light having a wavelength around 13.4 nm. At this time, the principal ray of illumination light which becomes incident on the reflective reticle MS is set to match non-telecentricity on the object side of the reflection projection optical system 300. The EUV light reflected by the reflective reticle MS is reflected again by first to sixth reflecting mirrors 310 to 360 in this order. The first and fourth reflecting mirrors 310 and 340 are concave mirrors. The second, third, fifth, and sixth reflecting mirrors 320, 330, 350, and 360 are convex mirrors. The reflected light forms a reduced image of the pattern of the reflective reticle MS on the wafer W positioned on the image plane. The reflected light also forms an intermediate image MI of a real image between the fourth and fifth reflecting mirrors 340 and 350 along the optical path.

The reflection projection optical system 300 shown in FIG. 6 has the following performance:

an NA=0.25;

a reduction magnification=⅕×;

an arcuated image plane with an object height=130 mm to 140 mm, an image height=26 mm to 28 mm, and a width of 2.0 mm (corresponding to an arcuated slit, shown in FIG. 3, with a length in the X direction of 26 mm and a width in the Y direction of 2 mm); and

an overall length=1400 mm.

The reflection projection optical system 300 has almost the same specification as that of the projection optical system 100 according to this embodiment shown in FIG. 1.

Table 3 shows the numeric values (the radius of curvature R, the surface interval D, the refractive index N, the tilt angle θ, the conic constant k, and the aspherical coefficients) of the projection optical system 300 shown in FIG. 6. Note that D is the distance on the optical axis OA.

TABLE 3

| reflecting | | | | |
|---|---|---|---|---|
| mirror | | | | tilt angle θ |
| number | R | D | N | (°) |
| object | inf | 845.4594501 | 1 | 0.0 |
| plane (MS) | | | | |
| reflecting | −551.7047323 | −174.1785832 | −1 | |
| mirror 310 | | | | |
| reflecting | −580.1354764 | 227.9889933 | 1 | |
| mirror 320 | | | | |
| reflecting | 1626.4220641 | −352.2645860 | −1 | |
| mirror 330 | | | | |
| reflecting | 663.4273682 | 800.5649791 | 1 | |
| mirror 340 | | | | |
| reflecting | 336.9502262 | −417.9194680 | −1 | |
| mirror 350 | | | | |
| reflecting | 502.7261737 | 470.3505714 | 1 | |
| mirror 360 | | | | |
| image | inf | | | 0.0 |
| plane (W) | | | | |

Note that the tilt angle is the angle with respect to a plane perpendicular to the optical axis.

aspherical
data

| reflecting | | | |
|---|---|---|---|
| mirror | | | |
| number | k | A | B |
| reflecting | 0 | 1.845318051E−09 | −2.331787197E−14 |
| mirror 310 | | | |
| reflecting | 0 | 6.679967523E−09 | 6.565991712E−14 |
| mirror 320 | | | |
| reflecting | 0 | −1.236666562E−09 | 6.228166244E−14 |
| mirror 330 | | | |
| reflecting | 0 | −1.179037458E−11 | 1.856897766E−16 |
| mirror 340 | | | |
| reflecting | 0 | −5.128025282E−10 | 1.027757876E−12 |
| mirror 350 | | | |
| reflecting | 0 | 3.894856105E−11 | 2.079435870E−16 |
| mirror 360 | | | |

| reflecting | | | |
|---|---|---|---|
| mirror | | | |
| number | C | D | E |
| reflecting | 2.550678184E−19 | 4.066512968E−23 | −5.638049453E−27 |
| mirror 310 | | | |
| reflecting | 3.376677383E−16 | −4.642271768E−19 | 3.669578178E−22 |
| mirror 320 | | | |
| reflecting | −1.605527262E−17 | 2.902792871E−21 | −3.217624606E−25 |
| mirror 330 | | | |
| reflecting | −3.610384684E−21 | 5.028846102E−26 | −9.560189974E−31 |
| mirror 340 | | | |
| reflecting | 4.898951562E−17 | −6.843943948E−20 | 3.697210205E−23 |
| mirror 350 | | | |
| reflecting | 9.229533918E−22 | 6.946838877E−27 | −1.214946670E−30 |
| mirror 360 | | | |

| reflecting | | | | |
|---|---|---|---|---|
| mirror | | | | |
| number | F | G | H | J |
| reflecting | 3.691082908E−31 | −1.009307925E−35 | 0.000000000E+00 | 0.000000000E+00 |
| mirror 310 | | | | |
| reflecting | −9.207470948E−26 | −1.496668150E−29 | 0.000000000E+00 | 0.000000000E+00 |
| mirror 320 | | | | |
| reflecting | 1.982006377E−29 | −5.213615140E−34 | 0.000000000E+00 | 0.000000000E+00 |
| mirror 330 | | | | |
| reflecting | 1.740765223E−35 | −1.344362385E−40 | 0.000000000E+00 | 0.000000000E+00 |
| mirror 340 | | | | |
| reflecting | −1.078291156E−26 | 1.343601398E−30 | 0.000000000E+00 | 0.000000000E+00 |
| mirror 350 | | | | |
| reflecting | 6.689735685E−35 | −1.169377560E−39 | 0.000000000E+00 | 0.000000000E+00 |
| mirror 360 | | | | |

Assume that the projection optical system 300 has perfect telecentricity on the image side. Then, a tangent function which describes the telecentricity characteristic on the object side has a minimum value of 0.099558 at an object height of 130 mm, and has a maximum value of 0.107101 at an object height of 140 mm. This means that the projection optical system 300 has non-telecentricity on the object side. The angle of the principal ray with respect to the reflective reticle MS is assumed to be nearly 6° that is equal to that of the projection optical system 100 according to this embodiment for the sake of comparison.

Assuming that deterioration in evenness of the reflective reticle MS is 100 nm, the tangent value for a projected image at an object height of 140 mm is 0.107101. Moreover, since a reduction magnification=⅕×, an image shift on the image plane is 2.14 nm. This means that the adverse effect that the image shift inflicts on the overlay performance is too large to ignore.

An NA variable aperture ST is positioned on the second reflecting mirror 320, and defines all light beams involved in imaging. Table 4 shows the NA on the image plane corresponding to each object height at this time.

TABLE 4

| object height (mm) | NA(meri) | NA(sagi) | ΔNA(m-s) |
|---|---|---|---|
| 130 | 0.25384 | 0.26787 | 0.01403 |
| 135 | 0.25328 | 0.26764 | 0.01436 |
| 140 | 0.25268 | 0.26741 | 0.01473 |
| ΔNA image height | 0.001159 | 0.00046 | |
| difference | | | |

When compared to table 2 according to this embodiment, the ΔNA image height differences in meridional and sagittal NAs are 4.4 times and 5.7 times, respectively, and the maximum value of ΔNA(m-s) is 1.5 times. Hence, the projection optical system 100 according to this embodiment can reduce the difference in NA in the effective field region.

As described above, the projection optical system 100 according to this embodiment serves as an EUV imaging system which increases the degree of freedom of the positioning of illumination system mirrors, can attain good CD uniformity over the entire effective field region, and reduces degradation in overlay performance.

An exposure apparatus 200 to which a reflection projection optical system 100 according to the present invention is applied will be described below with reference to FIG. 2. The exposure apparatus 200 according to this embodiment is a projection exposure apparatus which performs exposure of the step & scan scheme using EUV light (wavelength: 13.4 nm etc.) as illumination light for exposure.

The exposure apparatus 200 includes an illumination system 210, a reticle MS, a reticle stage 220 which mounts the reticle MS, the reflection projection optical system 100, a substrate (wafer) W as a processing object, a substrate stage 230 which mounts the substrate W, and a controller 240. The controller 240 is controllably connected to the illumination system 210, reticle stage 220, and substrate stage 230.

Although not shown in FIG. 2, the atmosphere has a low transmittance for EUV light, so at least the optical path along which EUV light travels is subjected to a vacuum atmosphere. Note that in FIG. 2, the X, Y, and Z dimensions define a three-dimensional space, and the normal direction to the X-Y plane is defined as the Z direction.

The illumination system 210 illuminates the reticle MS with arcuated EUV light (wavelength: 13.4 nm etc.) corresponding to the arcuated effective field region of the reflection projection optical system 100. The illumination system 210 includes a light source and illumination optical system (neither is shown). The principal ray of the illumination light becomes incident on the reticle MS at an incident angle of 6.0° with respect to a normal to the reflecting surface of the reticle MS positioned to be tilted at 6.0° counterclockwise within the paper plane with respect to a plane (not shown) perpendicular to an optical axis OA of the reflection projection optical system 100. Note that the light source and illumination optical system which constitute the illumination system 210 can take any forms known to those skilled in the art, and a detailed description thereof will not be given in this specification. For example, the illumination optical system includes a condensing optical system, optical integrator, aperture stop, and blade, and can adopt any technique which can be assumed and achieved by those skilled in the art.

The reticle MS is a reflective reticle. The reticle MS has a circuit pattern (or an image) to be transferred formed on it, is supported by the reticle stage 220, and is driven within the X-Y plane while maintaining a tilt angle of 6.0°. Diffracted light generated by the reticle MS is projected onto the substrate W upon being reflected by the reflection projection optical system 100. The reticle MS and substrate W are positioned in an optically conjugate relationship. Since the exposure apparatus 200 is of the step & scan scheme, it reduces and projects the pattern of the reticle MS onto the substrate W by scanning them.

The reticle stage 220 supports the reticle MS and is connected to a moving mechanism (not shown). The reticle stage 220 can take any form known to those skilled in the art. The moving mechanism (not shown) includes, for example, a linear motor, and can move the reticle MS by driving the reticle stage 220 in at least the Y direction under the control of the controller 240. The exposure apparatus 200 scans the reticle MS and substrate W while the controller 240 synchronizes them.

The reflection projection optical system 100 is a catoptric system, which reduces and projects the pattern on the surface of the reticle MS onto the image plane. The reflection projection optical system 100 can take any of the above-mentioned forms, and a detailed description thereof will not be given. Although the reflection projection optical system 100 shown in FIG. 1 is used in FIG. 2, it is merely an exemplary form, and the present invention is not limited to this.

Although the substrate W is a wafer in this embodiment, it includes a wide variety of processing objects such as a liquid crystal substrate. The substrate W is coated with a photoresist. The photoresist coating step includes a preprocess, a process of coating the substrate with an adhesion enhancing agent, a process of coating the substrate with a photoresist, and a pre-baking process. The preprocess includes, for example, cleaning and drying. The process of coating the substrate with an adhesion enhancing agent is a surface modification process for enhancing the adhesion between a photoresist and the underlying layer, that is, a process of imparting a hydrophobic property to the substrate by coating it with a surfactant. In this process, the substrate is coated with an organic film such as HMDS (hexamethyldisilazane) or steamed. The pre-baking is a baking process but serves to more softly bake the photoresist than in baking after developing the photoresist. In this process, the solvent is removed.

The substrate stage 230 supports the substrate W. The substrate stage 230 moves the substrate W as a processing object in the X, Y, and Z directions using, for example, a linear motor. The reticle MS and substrate W are synchronously scanned under the control of the controller 240. Also, the reticle stage 220 and substrate stage 230 are driven at a constant speed ratio while a laser interferometer, for example, monitors their positions. Although the optical axis OA and the X direction are parallel in FIG. 2, the apparatus may be configured such that the optical axis OA is tilted at 1.2° with respect to the X direction, and the surfaces of the substrate W and substrate stage 230 are parallel to the Y-Z plane. Since the apparatus normally adopts the X direction as the gravitational direction, the latter configuration may be more desirable from the viewpoint of exploiting the same stage technique as in the prior art.

The controller 240 includes a CPU and memory (neither is shown) and controls the operation of the exposure apparatus 200. The controller 240 is electrically connected to the illumination system 210, the reticle stage 220 (i.e., a moving mechanism (not shown) for the reticle stage 220), and the substrate stage 230 (i.e., a moving mechanism (not shown) for the substrate stage 230). The CPU includes all processors such as an MPU irrespective of their names, and controls the operation of each unit. The memory includes a ROM and RAM, and stores firmware which operates the exposure apparatus 200.

In exposure, EUV light emitted by the illumination system 210 illuminates the reticle MS to form an image of the pattern on the surface of the reticle MS on the surface of the substrate W. In this embodiment, the image plane has an arcuated (ring-like) shape, and the entire surface of the substrate W is exposed by scanning the reticle MS and substrate W at a speed ratio equal to the reduction magnification ratio.

An exemplary method of manufacturing devices such as a semiconductor integrated circuit device and a liquid crystal display device using the exposure apparatus 200 will be explained next.

The devices are manufactured by a step of transferring by exposure a pattern formed on a reticle onto a substrate, a step of developing the exposed substrate, and other subsequent steps of processing the developed substrate. The other subsequent steps include, for example, etching, resist removal, dicing, bonding, and packaging steps.

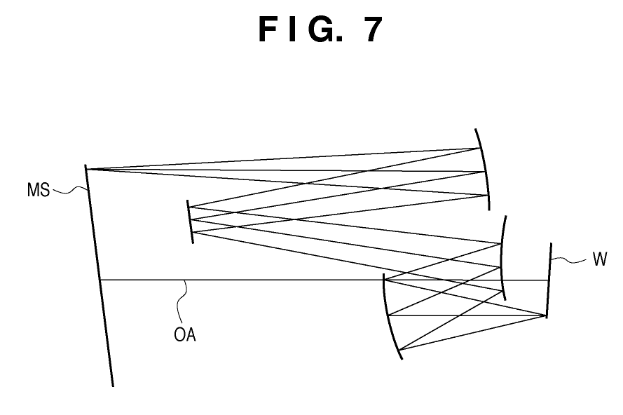

Although embodiments of the present invention have been explained above, the present invention is not limited to these embodiments as a matter of course, and various modifications and changes can be made without departing from the spirit and scope of the present invention. For example, the number of times of imaging using the reflection projection optical system 100 may be one (see FIG. 7) or three as a whole. Moreover, although the reflection projection optical system 100 according to this embodiment is a coaxial system having a rotationally symmetrical aspherical surface, the present invention is not limited to this. Instead, the reflection projection optical system 100 may have a non-rotationally-symmetrical aspherical surface. The reflecting mirrors of the reflection projection optical system 100 may not be positioned to form a perfect coaxial system in consideration of aberration correction or aberration adjustment. Instead, the aberration of the reflection projection optical system 100 may be improved by a small amount of decentering. The present invention can also be embodied as a reflection projection optical system for ultraviolet rays, with a wavelength of 200 nm or less, such as an ArF excimer laser beam or an F₂ laser beam, in place of EUV light. Also, the present invention is applicable to both of an exposure apparatus which performs scanning exposure of a wide field and that which performs exposure without scanning.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-277376, filed Oct. 28, 2008, which is hereby incorporated by reference herein in its entirety.

What is claimed is:

1. A reflection projection optical system which projects a pattern positioned on an object plane onto an image plane via a mirror,
wherein the system
has bilateral telecentricity on a side of the object plane and a side of the image plane, and
has the object plane and the image plane positioned to be tilted with respect to a plane perpendicular to an optical axis of the system so as to satisfy a Scheimpflug condition.

2. The system according to claim 1, wherein
letting θ be a tilt angle of the object plane with respect to the plane perpendicular to the optical axis, and NAO be a numerical aperture of the system on the side of the object plane, the object plane is positioned to be tilted with respect to the plane perpendicular to the optical axis such that the tilt angle θ satisfies:
sin⁻¹(NAO)<θ<sin⁻¹(NAO)+5.0

3. The system according to claim 2, wherein
the object plane is positioned to be tilted with respect to the plane perpendicular to the optical axis such that the tilt angle e satisfies:
sin⁻¹(NAO)<θ<sin⁻¹(NAO)+3.0

4. An exposure apparatus comprising:
a reflection projection optical system configured to project a pattern of a reticle positioned on an object plane onto a substrate positioned on an image plane via a mirror,
wherein the system
has bilateral telecentricity on a side of the object plane and a side of the image plane, and
has the object plane and the image plane positioned to be tilted with respect to a plane perpendicular to an optical axis so as to satisfy a Scheimpflug condition.

5. A method comprising:
exposing a substrate using an exposure apparatus;
developing the exposed substrate; and
processing the developed substrate to manufacture a device,
wherein
the exposure apparatus includes,
a reflection projection optical system which projects a pattern of a reticle positioned on an object plane onto a substrate positioned on an image plane via a mirror,
wherein the system
has bilateral telecentricity on a side of the object plane and a side of the image plane, and
has the object plane and the image plane positioned to be tilted with respect to a plane perpendicular to an optical axis of the so as to satisfy a Scheimpflug condition.
